(19) United States
(12) Patent Application Publication
(10) Pub. No.: US 2023/0187752 A1
(43) Pub. Date: Jun. 15, 2023

(54) Holding Device for Battery Cells

(71) Applicant: Bayerische Motoren Werke Aktiengesellschaft, Muenchen (DE)

(72) Inventors: Franz FUCHS, Muenchen (DE); Kevin GALLAGHER, Naperville, IL (US); Martin HILLER, Karlsfeld (DE); Christophe MILLE, Villard de Lans (DE); Frederik MORGENSTERN, Mountain View, CA (US); Nikolaos TSIOUVARAS, Athen (GR); Seokyoon YOO, Baldham (DE)

(21) Appl. No.: 17/916,839

(22) PCT Filed: May 17, 2021
(86) PCT No.: PCT/EP2021/062909

§ 371 Date: Oct. 4, 2022

(30) Foreign Application Priority Data
Jun. 17, 2020 (DE) 10 2020 115 924.2

(51) Int. Cl. H01M 50/213; H01M 50/249; H01M 50/509; H01M 10/658; H01M 50/293

(52) U.S. Cl. CPC H01M 50/213; H01M 10/658; H01M 50/249; H01M 50/293; H01M 50/509; H01M 2220/20

(57) ABSTRACT

A holding device for battery cells for constructing a high-voltage storage module which can be used for electrically operated motor vehicles is provided. The battery cells, in a P assembly (i.e. interconnected in parallel), are provided with a minimally thin thermal insulating layer and, encased in this way, are brought into direct contact with each other in a self-holding arrangement. The intermediate spaces between the battery cells, which battery cells have been provided with the insulating layer and, encased in this way, have been brought into contact with each other, are preferably filled with a thermally conductive potting compound. The thermally conductive potting compound can additionally have high electrical conductivity and thus, in addition to the heat transfer, can also establish the contacting of the anodes in the P assembly if the anodes are also encased by the potting compound.

### BACKGROUND AND SUMMARY OF THE INVENTION

The present invention relates to a holding device for battery cells, a plurality of which are installed in a battery module of a high-voltage accumulator, particularly for an electric vehicle or a hybrid vehicle.

For the supply of electrical energy, storage batteries, also described as batteries or accumulators, are known. For the supply of electric drive systems of vehicles, electrical energy at a comparatively high voltage, for example 400 V, is required, and the storage batteries employed for this purpose are also designated as high-voltage stores or drive batteries. At present, high-voltage stores of this type are not generally designed as monobloc units, but assume a modular structure comprised of a plurality of battery cells. This increases flexibility of design, and permits the employment of comparatively cost-effective standard cells, which can be manufactured as mass products, rather than individually customized items. The number of battery cells employed relates directly to the range of the electric or hybrid vehicle. In practice, for example, cylindrical cells or prismatic battery cells are employed as battery cells for high-voltage stores.

Moreover, high-voltage stores are frequently installed in the region of the passenger compartment or trunk of a vehicle, and occupy a considerable amount of space.

Consequently, there is a requirement for the identification of a design arrangement for the accommodation of a high-voltage store which compromises passenger comfort and storage space to the least possible extent. It is therefore endeavored, insofar as possible, to employ spaces for the accommodation of battery cells which serve no other purpose, and to achieve a high packing density of battery cells. A holding device of this type is known, for example, from DE 10 2016 206 463 A1, which is specifically formed by a plastic frame structure for insertion in the interspaces between the battery cells.

Moreover, in the event of a battery cell defect, a first battery cell can undergo “thermal runaway”, and can rupture in response to a strong increase in temperature. Hot gases and particles of carbon black are released as a result. Gases and particles thus released are distributed through the module, and can result in the heat-up of adjoining cells. If a temperature increase associated with this transfer of heat exceeds a critical threshold, further cells can also undergo “thermal runaway” (by thermal propagation).

A further problem is the lateral failure of the cell associated with thermal breakdown, also described as “side rupture”. As a result, a very large quantity of thermal energy can be transmitted to the adjoining cell in a very short time. Particularly in the event of the insulation of cells by air, thermal propagation by side rupture can only be controlled with difficulty.

One object of the present invention is the provision of a holding device for battery cells which is improved, with respect to the above-mentioned temperature issues.

This object is fulfilled according to the claimed invention.

The invention relates to a holding device for battery cells, for constructing a high-voltage storage module which can be employed for electrically-operated motor vehicles, wherein the battery cells, in a P assembly (i.e. interconnected in parallel), are provided with a minimally thin thermal insulating layer and, encased in this manner, are brought into direct contact with each other in a self-holding arrangement. According to a first alternative, the individual cells of the P assembly or, according to a second alternative, only the P assembly as a whole (with no insulating layer for individual cells) is provided with the thermal insulating layer. The cells in a P assembly are electrically isolated from adjoining cells, which are interconnected in a S (serial) assembly.

In a further development of the invention, the interspaces between battery cells, which battery cells have been provided with the insulating layer and, encased in this manner, are brought into contact with each other, are filled with a thermally conductive potting compound wherein, preferably, the anodes are also encased by the potting compound. Alternatively, the interspaces between the cells of a P assembly can also be filled with the potting compound, in the absence of an insulating layer for individual cells.

At the same time, the potting compound is simultaneously configured as an adhesive bond between the battery cells and a cooling plate.

In a further configuration of the invention, the potting compound has a high thermal conductivity, which can lie between the thermal conductivity of air and the thermal conductivity of the battery housing. Preferably, a thermal conductivity of at least 1 W/mK can be provided.

Preferably, the thermally conductive potting compound additionally has a high electrical conductivity and, additionally to heat transfer, is also employed for the contact-connection of anodes in the P assembly, where the anodes are also encased in the potting compound.

Preferably, by way of the insulating layer and/or the potting compound, the cell spacing is reduced to the order of 0.05 to 0.4 mm.

The invention is based upon the following considerations:

Customary endeavors for the prevention of “thermal propagation”, within battery modules which are constituted of a plurality of battery cells, comprise measures for the reduction of any temperature exchange between battery cells. It is thus intended to reduce the probability that thermal runaway in a battery cell, by way of heat transfer, will also result in the thermal runaway of adjoining cells. This is achieved at the expense of packing density.

According to embodiments of the invention, the battery cells, in the interests of increased packing density, are therefore arranged as close as possible, such that a temperature exchange is intentionally permitted. In place of thermal insulation, an improved and as uniform a temperature transfer as possible is thus ensured.

Thus, according to embodiments of the invention, a minimum thermal insulating layer is provided, which results in a comparatively small clearance (approximately 0.05 to 0.4 mm) between the battery cells such that, to a certain degree, “thermal contact”, i.e. a temperature transfer to the adjoining cell, occurs. A minimum insulating layer of this type can be achieved, for example, by way of a heat-shrink sleeve, a foil wrapping or a tape winding.

To date, in conventional high-voltage stores in the automobile sector, a cell clearance of approximately 1 to 3 mm has typically been provided, specifically between cylindrical cells. According to embodiments of the invention, it is intended that the cell clearance should be minimized to approximately 0.05 to 0.4 mm. By use of this tight packing density, no carrier or holder, in the conventional sense of the term, is required for the battery cells in a module, as they execute a mutual holding function. Additionally, no orientation of the cells is required, as a natural arrangement (or pack) is formed, particularly in a hexagonal pattern.

Preferably, battery cells which are packed in this manner are bonded to a cooling plate by way of a thermally conductive potting compound (e.g. adhesive or resin), wherein the thermally conductive potting compound is at least partially compressed into the voids between the battery cells, such that the battery cells are also secured to one another. Preferably, the potting compound is both thermally and electrically conductive.

In a particularly preferred exemplary embodiment, the following measures are thus implemented in combination:
The cells are provided with a very thin thermal insulating layer (0.05 to 0.4 mm) and thereafter - encased in this manner - are brought into direct contact with one another. Accordingly, the clearance between the cells is itself dictated by the thin insulating layer.
In order to prevent any thermal, and particularly lateral breakdown (thermal runaway or side rupture), interspaces between the thus encased and thereafter as tightly packed as possible cells are filled with a thermally conductive potting compound (e.g. filling foam, adhesive, resin, etc.). The higher the thermal conductivity of the potting compound, the better the transfer of heat between the cells. If the thermal conductivity is similar to that of the metal battery housing, heat is then released in a particularly uniform manner to the adjoining cells. Propagation can be suppressed as a result. It is particularly important that the most uniform possible heat-up of cells should be achieved. It is intended that an expansive transfer of heat to adjoining cells should take place in a wider environment, and not just at those points where they are in physical contact with the cell housing.
The thermally conductive potting compound should, in addition, preferably have a high electrical conductivity (e.g. graphite, carbon, metal particles or metal wool). The cells are only packed and adhesively bonded in a P assembly (interconnected in parallel). Only the electrical insulation of each P assembly is required. The electrically conductive potting compound thus constitutes no impediment to this effect, and is thus simultaneously employed for the contact-connection of anodes in the P assembly.
Alternatively (but also as an independent inventive idea), in place of an insulating layer around each cell, only one insulating layer around a P assembly of cells can be provided, wherein the cells within the P assembly are thus brought into electrical contact via the cell casings (in the case of steel casings, at the anode potential) and wherein, in this case, interspaces between the individual cells in a P assembly are again filled with a thermally and electrically conductive potting compound.

The invention is described hereinafter with reference to a preferred exemplary embodiment, in consideration of the attached figures. The representation shown in the figures is to be understood as schematic only.

### BRIEF DESCRIPTION OF THE DRAWINGS

FIG. 1 shows a schematic overhead view and a sectional view of battery cells which are provided with a thin thermal insulating layer, are tightly packed, and the interspaces thereof are filled with a potting compound.

FIG. 2 shows the action of two different potting compounds having different thermal conductivities.

FIG. 3 shows an overhead view of battery cells, the anodes of which are contact-connected by way of an electrically conductive and thermally conductive potting compound.

### DETAILED DESCRIPTION OF THE DRAWINGS

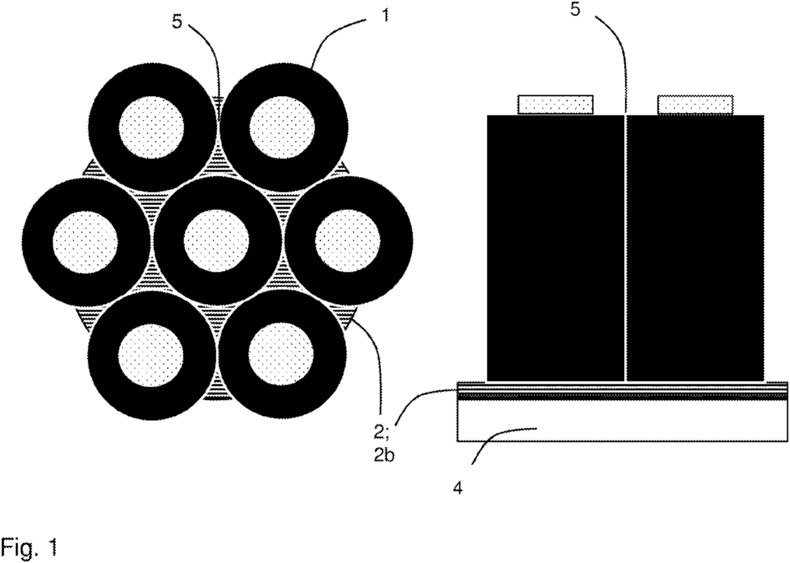

FIG. 1 shows a schematic representation of battery cells 1, which are provided with a very thin thermal insulating layer of approximately 0.05 to 0.4 mm (represented by the thin white ring around the black battery housing) and, encased in this manner, are brought into direct contact with one another. Accordingly, the clearance 5 itself between the cells 1 is defined by the thin insulating layer.

In order to prevent thermal breakdown, and particularly side rupture, interspaces between the cells 1 thus encased, and thereafter “packed” as tightly as possible, are filled with a thermally conductive potting compound 2 (e.g. filling foam, adhesive, resin, etc.). At the same time, the cells 1 are secured to a cooling plate 4 by way of the preferably adhesive potting compound 2.

The higher the thermal conductivity of the potting compound 2, the better the transfer of heat between the cells. If the thermal conductivity is similar to that of the metal battery housing, heat is then released in a particularly uniform manner to the adjoining cells. Propagation can be suppressed as a result.

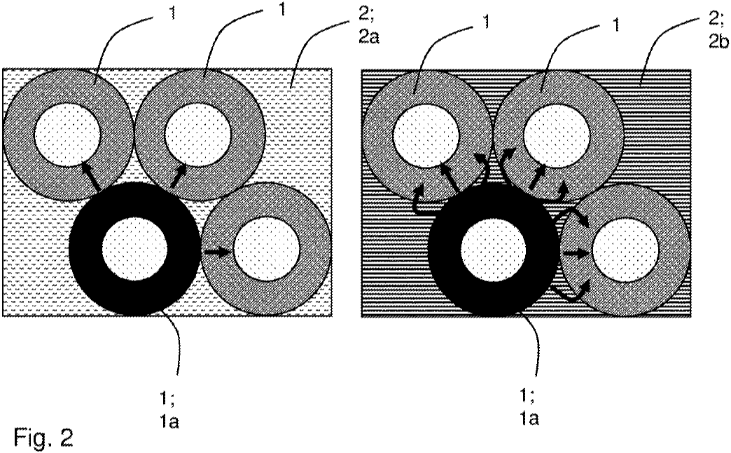

In FIG. 2, short arrows illustrate the conductivity of two different potting compounds 2a and 2b. The left-hand side of FIG. 2 shows a potting compound 2a having a lower thermal conductivity than the potting compound 2b on the right-hand side of FIG. 2.

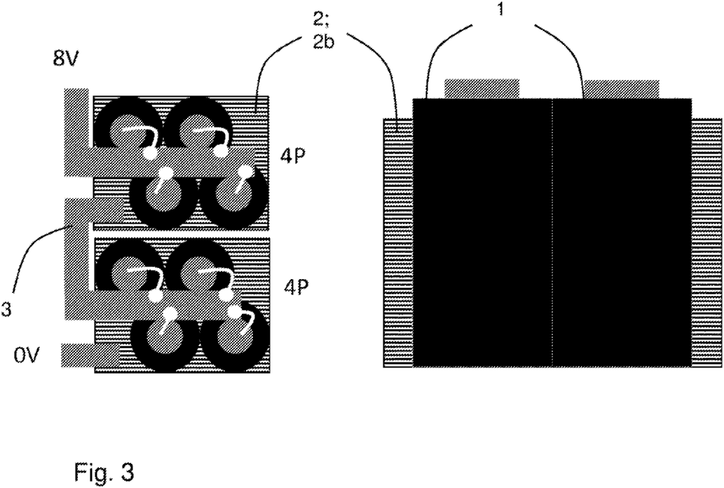

The thermally conductive potting compound 2 (2b) should also preferably have a high electrical conductivity. This is illustrated with reference to FIG. 3. The cells 1 are only packed and adhesively bonded in a P assembly (interconnected in parallel). The additionally electrically conductive potting compound 2 (2b) thus executes the contact-connection 3 of anodes in the P assembly. According to a first alternative, the individual cells of the P assembly or, in a second alternative, only the P assembly as a whole (with no individual cell insulating layer) can be provided with the thermal insulating layer.

In summary, the invention thus relates to a holding device for battery cells 1, for constructing a high-voltage storage module which can be employed for electrically-operated motor vehicles, wherein the battery cells 1, in a P assembly (i.e. interconnected in parallel), are provided with a minimally thin thermal insulating layer and, encased in this manner, are brought into direct contact with each other in a self-holding arrangement. Interspaces between the battery cells 1 which have been provided with the insulating layer and, encased in this manner, are brought into contact with each other, are preferably filled with a thermally conductive potting compound 2. The thermally conductive potting compound 2 can additionally have a high electrical conductivity and thus, additionally to the transfer of heat, can execute the contact-connection of anodes in the P assembly, where the anodes are also encased by the potting compound 2.

1-9. (canceled)

10. A holding device for battery cells, for a high-voltage storage module which is usable in electrically-operated motor vehicles, wherein the battery cells are in a P assembly and are brought into direct contact with each other in a self-holding arrangement, the holding device comprising:
a minimally thin thermal insulating layer that encases each of the battery cells.

11. A holding device for battery cells, for a high-voltage storage module which is usable in electrically-operated motor vehicles, wherein the battery cells are in a P assembly and are brought into direct contact with each other in a self-holding arrangement, the holding device comprising:
a minimally thin thermal insulating layer that only encases the P assembly.

12. The holding device according to claim 10, wherein interspaces between the battery cells are filled with a thermally conductive potting compound.

13. The holding device according to claim 11, wherein the battery cells are brought into electrical contact via cell casings, and interspaces between the battery cells are filled with a thermally and electrically conductive potting compound.

14. The holding device according to claim 12, wherein the potting compound is simultaneously configured as an adhesive bond between the battery cells and a cooling plate.

15. The holding device according to claim 13, wherein the potting compound is simultaneously configured as an adhesive bond between the battery cells and a cooling plate.

16. The holding device according to claim 12, wherein the potting compound has a high thermal conductivity, which is at least close to a thermal conductivity of the battery housing.

17. The holding device according to claim 13, wherein the potting compound has a high thermal conductivity, which is at least close to a thermal conductivity of the battery housing.

18. The holding device according to claim 12, wherein the thermally conductive potting compound has a high electrical conductivity and, additionally to heat transfer, is also configured for contact-connection of anodes in the P assembly, wherein the anodes are also encased in the potting compound.

19. The holding device according to claim 13, wherein the thermally conductive potting compound has a high electrical conductivity and, additionally to heat transfer, is also configured for contact-connection of anodes in the P assembly, wherein the anodes are also encased in the potting compound.

20. The holding device according to claim 12, wherein, by way of the insulating layer and/or the potting compound, a spacing between adjacent battery cells is reduced to between 0.05 and 0.4 mm.

21. The holding device according to claim 13, wherein, by way of the insulating layer and/or the potting compound, a spacing between adjacent battery cells is reduced to between 0.05 and 0.4 mm.

22. A vehicle comprising a high-voltage store, which comprises the holding device according to claim 10.

23. A vehicle comprising a high-voltage store, which comprises the holding device according to claim 11.
